(19) United States
(12) Patent Application Publication
(10) Pub. No.: US 2025/0259210 A1
(43) Pub. Date: Aug. 14, 2025

(54) SYSTEM AND METHOD FOR DISPLAYING ADVERTISING BOARDS

(71) Applicants: Jacob Elmon, London (GB); Brandon Elmon, London, (GB)

(72) Inventors: Jacob Elmon, London (GB); Brandon Elmon, London, (GB)

(21) Appl. No.: 18/678,450

(22) Filed: May 30, 2024

Related U.S. Application Data
(63) Continuation-in-part of application No. 18/438,573, filed on Feb. 12, 2024.

(51) Int. Cl. G06Q 30/0241; A63F 13/61; G06F 3/01; G06F 3/0488; G06T 19/00; G06V 20/20

(52) U.S. Cl. CPC G06Q 30/0276; A63F 13/61; G06F 3/011; G06T 19/006; G06V 20/20; G06F 3/0488; G06T 2200/24

(57) ABSTRACT

The present invention relates to Augmented Reality (AR) advertising in taxi rides. More specifically the invention relates to a mobile application utilizing existing taxi application maps for immersive, landmark-triggered AR advertisements. The disclosed landmark-triggered advertising in taxi rides provides the alignment of ads with specific landmarks on the user's route, the invention provides relevant and engaging content based on their potential interests and location.

### CROSS REFERENCE TO RELATED APPLICATIONS

The present invention is an improvement or modification of the invention claimed in the complete specification of the main application Ser. No. 18/438,573 filed on Feb. 12, 2024.

### FIELD OF THE INVENTION

The present invention relates to display advertising boards and art. More specifically the invention relates to a mobile application utilizing existing taxi application maps for immersive, landmark-triggered AR (Augmented Reality) advertisements.

### BACKGROUND OF THE RELATED ART

The various mobile ad advertising in taxi rides existed in prior arts which deliver personalized content to users during rides and displaying advertising boards and art through mobile app.

Few existing prior arts related to the above context include U.S. Patent publication no. US20230342816A1 to Individual teaches an advertising method which contains an advertisement that can feature a concise message. Users have the option to explore advertisements from local businesses. Businesses can effortlessly create and oversee ads directly, without any intermediaries. If a business's ad is displayed to a user within a vehicle, the ad might include an interactive button to initiate a purchase process. Additionally, the ad may incorporate a button for users to command the vehicle to navigate to the business.

Another U.S. Patent no. JP5699116B2 to Yahoo Japan Corp teaches an advertisement distribution device comprises the following components a vehicle equipped with an output device for presenting vehicle state information, a user's portable terminal used while in the vehicle, and the advertisement distribution device itself responsible for delivering ads to the user's portable terminal. This device includes acquisition means to gather both the vehicle state information and the user's identifier, and advertisement determination means to decide which ads should be sent to the user's portable terminal. The determination is based on the traveling state, discerned by the determination means, selecting ads either associated with the region matching the current travel position or unrelated regions to the ongoing travel position.

Another U.S. Patent no. US20230143472A1 to Dish Network LLC teaches a system in which businesses can harness the widespread use of ride-sharing services to incorporate intelligent and relevant advertisements into a communication protocol. This integration occurs in real-time as ride-sharing users travel past physical advertisements. This approach contrasts with the inefficient method of disseminating advertisements without considering a user's location or preferences.

Another U.S. Patent no. U.S. Pat. No. 10,366,290B2 to Baidu USA LLC teaches an in-vehicle information and entertainment system that is employed to deliver content suitable for presentation in a virtual reality (VR) format within an autonomous vehicle. The content is determined and displayed considering the autonomous vehicle passengers' information, such as navigation and recommendations, as well as entertainment applications like learning and gaming. This involves integrating augmented and/or virtual reality with cloud rendering and streaming, with a specific emphasis on usability within the context of autonomous driving.

Another U.S. Patent no. U.S. Pat. No. 10,600,077B2 to Asad Arshad, Bradford teaches an advertising platform comprises one or more ads, at least one identification tool, and a consumer portal. This portal connects to a database containing information about the ads and additional data concerning the use of the identification tool. This setup enables the application of cost per lead or cost per acquisition advertising strategies to printed ad campaigns.

Another U.S. patent no. U.S. Pat. No. 10,977,865B2 to Seyed-Nima Yasrebi teaches a system that enables a vehicle user to observe at least one augmented reality (AR) image depicting a section of the vehicle's surroundings. This involves utilizing at least one real-world camera to capture images of the surroundings and at least one display to present the AR image to the user. Data regarding the location, orientation, and field of view of the real-world camera are collected, and a virtual-world camera with similar characteristics is generated to capture images of corresponding virtual-world data. The AR image is then created by merging the virtual and real-world images.

Another U.S. Patent no. WO2023182965A2 to Bayraktar Caner teaches an invention that presents an advertising display system leveraging augmented, mixed, and virtual reality technologies. Its key functionality involves utilizing cameras on user devices like mobile phones, computers, smartwatches, and smart glasses to access a networked database. This system processes personal and Google data concurrently to generate feedback via a mobile application on these user devices. It then filters the processed data, identifies target points using the user device cameras, and generates personalized 2D and/or 3D advertisement visuals.

Imagine static billboards or posters lining the streets. They're fixed, unchanging images, often repeated multiple times throughout the journey. This redundancy dulls their impact. Passengers quickly tune out the familiar visual, failing to register the message or engage with the content. The ads are passive, demanding nothing from the user except passive observation. There's no call to action, no interactive element, no incentive to pay attention. This further contributes to disengagement.

Traditional ads often target a broad audience, aiming for mass appeal with generic messages. This misses the mark when it comes to individual passengers. Each person has unique interests, needs, and desires. An ad promoting a luxury watch might resonate with a business traveler but be irrelevant to a student on their way to class. The lack of personalization in ad content leaves a disconnect between the message and the individual passenger, undermining the potential for emotional connection and brand impact.

Traditional ads are one-way streets. The message flows from the advertiser to the passenger, with no avenue for communication or interaction. This static interaction model limits the effectiveness of the ad. Interactive elements like touchscreens or augmented reality overlays are rare in traditional in-transit advertising. This absence of interactivity reduces the potential for a deeper engagement and leaves passenger's passive recipients of the message.

Traditional ads fail to grab attention, resonate with their audience, or influence purchasing decisions. They become wasted expenses for advertisers and contribute to negative perceptions of brands. Passengers feel annoyed, bored, or disrespected by intrusive, irrelevant ads. This can contribute to a negative overall travel experience. The potential for creating engaging and informative experiences for passengers during their transit time remains untapped.

Traditional AR displays often showcase generic or irrelevant ads, missing opportunities for targeted campaigns based on user preferences and surroundings. AR ads rarely offer seamless ways for users to interact with the displayed content or follow through on calls to action. Taxi rides are relatively brief, restricting the time advertisers must engage with users through AR.

The existing prior arts provide traditional in-transit in taxi rides consisting of static posters, screens, and audio announcements, faces several problems such as lack of engagement, lack awareness of the user's travel route, destination, or purpose, missing opportunities for contextual relevance, ineffective Ad campaigns, poor user's experience, and missed opportunities for advertisers. The present invention provides landmark-triggered advertising in taxi rides utilizing journey data and geofencing, ads are placed along the user's route, potentially aligning with their interests or locations they're approaching. This increases relevance and engagement. Interactive elements like AR overlays or location-triggered information can create engaging ad experiences, making them more memorable and impactful.

These traditional methods rely on established channels and mediums to reach target audiences and promote products or services. While they may lack the interactive and immersive qualities of augmented reality, they have been effective in advertising and marketing for many years.

### SUMMARY OF THE INVENTION

The present invention discloses landmark-triggered advertising in taxi rides. The disclosed landmark-triggered advertising in taxi rides provides the alignment of ads with specific landmarks on the user's route, the invention provides relevant and engaging content based on their potential interests and location.

According to embodiments of the present invention, the system for landmark-triggered advertising in taxi rides contains a user smartphone which acts as the primary interface for the user, displaying the navigation map, AR overlays, and ad content, a cellular network that provides internet connectivity for the user smartphone to access real-time traffic data, navigation updates, and AR ad content from the servers, a taxi application server which coordinates with the geofence database to identify relevant landmarks on the user's route, AR ad content server that hosts pre-downloaded AR ad content associated with specific landmarks in the geofence database and geofence database that stores spatial data defining virtual boundaries (geofences) around predefined landmarks along various taxi routes.

According to the present invention, the mobile application utilizing taxi app maps for immersive, landmark-triggered ads. The mobile imports the user's planned route from the taxi app, typically via an API integration. Based on the acquired route data and the user's real-time location, the app identifies relevant landmarks, Traffic Light Stops (generally stopping of a vehicle or person) or notable places along the way. As the user enters a trigger zone (geofences) based on identified landmark, the application detects it and prepares to initiate the ad experience. The mobile application pre-downloads relevant immersive ad content for potential trigger zones based on predicted ad categories for each landmark using user preferences, travel purpose, and time of day. When a trigger zone is activated, the mobile application sends a subtle notification to the user's phone. This could be a vibration, a subtle visual alert, or a brief audio cue. The mobile application presents pre-downloaded immersive ad content associated with the triggered landmark such as AR, 3D models and branded videos or images. Advertisements will be incorporated into app's map interface, appearing as icons or banners at specific locations. The mobile application monitors user interaction with the ad and provides ways for users to offer feedback on the ad experience and preferred ad types. The collected data on user engagement, feedback, and travel patterns is analyzed to continually improve the application's functionality.

According to embodiments of the present invention utilizes a predetermined route from a taxi app to display immersive ads, providing stability and accuracy. The predetermined route from taxi app and track user's real-time location. The application identifies landmarks along the route based on location data and pre-loaded database. The application checks if user enters a trigger zone around a relevant landmark and selects pre-downloaded immersive ad content based on predicted ad categories and context. The application sends a subtle notification to alert the user about the triggered ad and waits for user action (viewing notification, pulling up phone). The application displays pre-loaded immersive ad content, utilizing AR, 3D models, or videos. The application monitors user interaction with the ad and collects feedback and utilizes collected data to optimize ad selection, trigger zone accuracy, and overall user experience.

According to embodiments of the present invention, a system for landmark-triggered advertising in taxi rides first determines if the user's chosen route is compatible with AR advertising. If yes, an arrow indicating “user interaction” is displayed, signaling upcoming AR experiences and if no, the taxi application proceeds as usual without AR functionality. The system continuously monitors the user's location and proximity to designated AR triggers along the route. If no trigger detected, the taxi application continues without AR interactions until the next potential trigger point. If trigger detected, identify AR object and display it on user's phone. The user is presented with the AR object and given the opportunity to interact, either user ignores AR objects or users clicks/grabs AR objects. Upon reaching the destination, the AR mode is closed. The user's total accumulated rewards, earned through AR interactions, are prominently displayed.

According to an embodiment of the present invention, the network architecture has a passenger device that acts as the window to the immersive ads, displaying them in an engaging and interactive format. The taxi system, GPS sensor, and internet router provide the real-time data and connectivity needed for ad triggering. The ad server and ad network manage the ad content, selection, and delivery based on user location and landmark triggers. The external server handles any additional data processing or user management tasks.

According to yet another embodiment of the present invention, the taxi system tracks the user's location throughout the ride. When the user approaches a pre-defined landmark, the mobile application receives a notification from the taxi system (or by directly detecting the location). The application triggers the corresponding AR ad associated with the landmark, displaying it on the user's device screen and the advertising boards popularly known as Billboards. The user can view the ad, interact with its elements, and potentially earn reward points based on their engagement. At the end of the ride, the application may display the accumulated reward points and offer redemption options.

### BRIEF DESCRIPTION OF THE ACCOMPANYING DRAWINGS

The accompanying drawing illustrates the present invention and, together with the description, explains the principles of the invention according to the embodiments. One skilled in the art will recognize that the particular embodiments illustrated in the drawings are merely exemplary and are not intended to limit the scope of the present invention.

FIG. 1 illustrates a network architecture of the system.

FIG. 2 illustrates a flowchart outlines the core functionality of the mobile application utilizing taxi app maps for immersive, landmark-triggered ads.

FIG. 3 illustrates a block diagram showing a system incorporating mobile application utilizing taxi application maps for immersive landmark ads.

FIG. 4 illustrates a flowchart showing a system for immersive landmark-triggered advertising in taxi rides.

FIG. 5 illustrates a landmark-triggered mobile AR ad system utilizing reward collection at the end of journey.

FIG. 6 illustrates the complex network of interactions and components involved in delivering augmented reality advertisements within a taxi environment.

FIG. 7 illustrates a flowchart visualizing the sequence of steps involved in using the AR taxi app for interacting with advertising boards and art.

FIG. 8 illustrates a block diagram illustrating the components and flow of the AR Taxi app for interacting with advertising boards and art.

FIG. 9 illustrates network architecture of the AR Taxi app for interacting with advertising boards and art.

### DETAILED DESCRIPTION OF THE RELATED ART

The embodiments herein and the various features and advantageous details thereof are explained with reference to the non-limiting example in the following description. The example used herein is intended merely to facilitate an understanding of how the embodiments herein may be practised and to further enable those of skill in the art to practice the embodiments herein.

Unless otherwise defined, all terms (including technical and scientific terms) used herein have the same meaning as commonly understood by one of the ordinary skills in the art of this disclosure. It will be further understood that terms, such as those defined in commonly used dictionaries, should be interpreted as having a consistent meaning in the context of the specification and should not be interpreted in an idealized or overly formal sense unless expressly so defined herein. Well-known functions or constructions may not be described in detail for brevity or clarity.

Landmark-triggered AR advertising in taxi rides according to embodiments of the present invention is characterized to provide a mobile application utilizing existing taxi app map networks to display ads along a user's route, triggered by specific landmarks. According to the present invention, by embracing personalized targeting and moving beyond generic approaches, Taxi application creates a more effective and engaging advertising platform for both users and advertisers. This can lead to higher ad conversion rates, improved user satisfaction, and a stronger brand reputation.

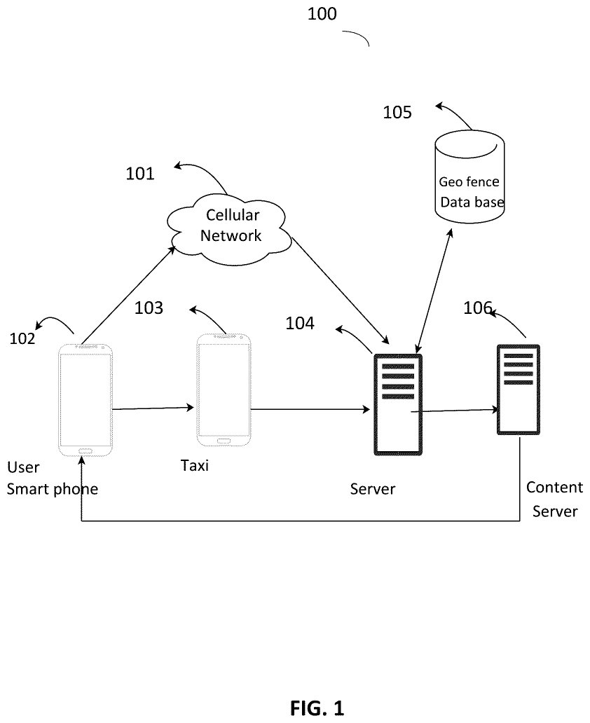

FIG. 1 illustrates a network architecture of the system. The architecture of landmark-triggered AR advertising in taxi rides (100) according to the present invention includes cellular network (101), user smartphone (102), taxi application server (104), geofence database (105), AR ad content server (108).

According to embodiments of the present invention, the network architecture of the landmark-triggered AR advertising in taxi driver comprising a user smartphone (102) which acts as the primary interface, displaying navigation maps, ad notifications, and the AR ad itself and equipped with GPS and accelerometers to track location and movement, enabling accurate ad triggering. The user smartphone (102) connects to the cellular network (101) for real-time data exchange and ad content downloading. The user smartphone (102) has a camera that is used for potential Augmented Reality (AR) features in the ad experience. The user smartphone (102) optionally has haptic feedback features that provides subtle vibration notifications for landmark triggers. The cellular network (101) provides internet connectivity for the user's smartphone, enabling communication with the taxi application server, AR ad content server, and downloads of AR ad content. The taxi application (103) manages booking, trip details, and navigation instructions and may provide user location data to the ad system with user consent. The taxi application (103) sends the user's route information to the taxi application server (104), which helps identify potential landmarks for ad triggers.

Further, architecture 100 comprises a taxi application server (104) acts as a central hub, coordinating communication between components. Further, taxi application server (104) consists of API gateway that enables communication between the taxi application (103) and the user's mobile application (102) for route access and location updates and cloud storage to store pre-downloaded immersive ad content for stability and faster delivery. The taxi application server (104) receives route information from the taxi application and user location data from the smartphone. The taxi application server (104) matches the user's route with the geofence database (105) to identify relevant landmarks for ad triggers and sends triggered landmark information to the AR ad content server (105). The geofence database (105) stores virtual boundaries (geofences) around predefined landmarks along various taxi routes. Each geofence holds information about associated landmarks and pre-downloaded AR ad content which is further used by the taxi application server (104) to identify relevant landmarks based on the user's proximity. The AR ad content server (106) as shown in FIG. 1 hosts pre-downloaded immersive AR ad content associated with specific landmarks. The AR ad content server (106) receives triggered landmark information from the taxi application server (103) and sends the corresponding AR ad content and instructions to the user's smartphone (102) for display.

Furthermore, according to embodiments of the present invention, the operating process of the working of the architecture (100) of landmark-triggered AR advertising in taxi rides is very simple. Upon launching the taxi booking application (103), users encounter available cabs in the vicinity. The GPS is automatically activated upon opening the application (103) to track the user's current location. In the very first during journey, the user inputs their destination in the taxi application (103), then taxi application (130) sends the planned route to the tax application server (104). Further the taxi application server (140) matches the route with the geofence database (105), identifying potential landmarks for ad triggers. As the user approaches a geofence, the server (104) sends a trigger signal to the AR ad content server (106). The AR ad content server (106) sends the relevant pre-downloaded AR ad content and instructions to the user's smartphone (102). The user's smartphone (102) displays the AR ad overlaying the real-world view, creating an immersive experience and users can engage with the AR ad through various elements like buttons, 3D models, or gamified features.

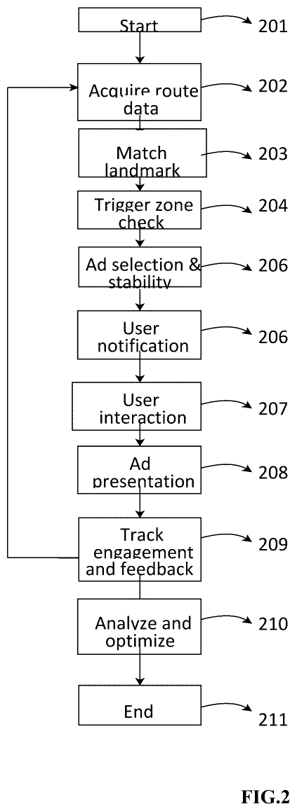

FIG. 2 illustrates a flowchart that outlines the core functionality of the mobile application which must be integrated inside the user's smartphone (102) utilizing taxi application (103) maps for immersive, landmark-triggered ads. FIG. 2 starts with acquiring route data (202) in which the mobile application imports the user's planned route from the taxi application (103), typically via an API integration. This includes information like waypoints, landmarks, and estimated travel time. Additionally, the application starts tracking the user's real-time location through the taxi application's GPS data. The next step involves matching landmarks (203) which is based on the acquired route data and the user's real-time location, the application identifies relevant landmarks along the way. This likely involves comparing the user's position with pre-loaded coordinates of landmarks stored in a database within the application. Trigger zone check (204) is the next step as shown in FIG. 2. Around each identified landmark, a predefined “trigger zone” (geofence) is established. As the user enters a trigger zone, the application detects it and prepares to initiate the ad experience. The method is proceeded with the ad selection and stability (205). To ensure a smooth and immediate ad experience, the application pre-downloads relevant immersive ad content for potential trigger zones based on predicted ad categories for each landmark using user preferences, travel purpose, and time of day, and route analysis to anticipate possible trigger zones. This pre-downloading approach prioritizes stability and avoids latency issues during the actual ad viewing.

The method progresses with the next step which involves user notification (206) step. In one embodiment, when a trigger zone is activated, the application sends a subtle notification to the user's smartphone (102). This could be a vibration, a subtle visual alert, or a brief audio cue. The purpose is to gently inform the user about the nearby landmark and potential ad without being intrusive. The application waits for the user to act, such as viewing the notification or interacting with it (tapping, swiping), and physically pulling up their phone to actively engage with the ad experience (207). This ensures that the ad only displays when the user is receptive and not disruptive to their travel. Upon user interaction, the application (208) presents the pre-downloaded immersive ad content associated with the triggered landmark. This could involve augmented reality (AR) which overlaying interactive 3D models or visual elements onto the live camera feed, showcasing the landmark and ad information in context, 3D models which displaying interactive 3D models of products or landmarks related to the ad and branded videos/images playing engaging videos or showcasing captivating images promoting the brand. The next step involves track engagement & feedback (209) in method 200 as shown in FIG. 2. The application monitors user interaction with the ad, including ad views and viewing duration, clicks on any interactive elements within the ad, and conversions (such as purchases, website visits). The application also provides ways for users to offer feedback on the ad experience and preferred ad types.

In another embodiment of the present invention, the application collected data on user engagement, feedback, and travel patterns is analyzed to continually improve the app's functionality. This optimization (210) can include refining ad selection algorithms for personalized and relevant ad experiences, adjusting trigger zone accuracy to ensure timely and appropriate ad triggers and refining the content and format of immersive ads for better user engagement. The application continues monitoring the user's location and landmark triggers throughout the remaining route. Each step from identifying landmarks to presenting ads and collecting data repeats for subsequent trigger zones encountered during the trip. Once the user reaches the destination, the ad delivery process, and data collection stop (202).

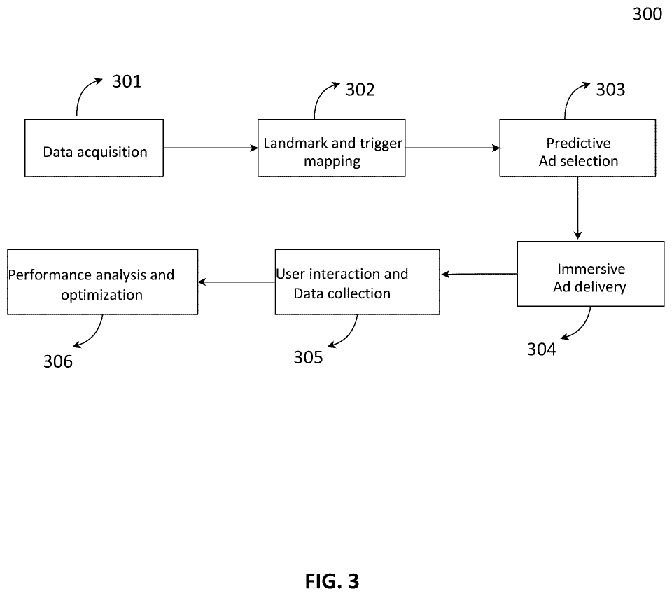

FIG. 3 illustrates a block diagram of the system in which mobile application utilizing taxi application maps for immersive landmark ads. Data acquisition (301) is the first step in method 300 in which API integration with existing taxi application to access user's real-time location and planned route and access the existing map data from the taxi app, including landmarks, POI (points of interest), and street information. The mobile application imports the planned route from the taxi application, including waypoints, landmarks, and estimated travel time and continuously track the user's real-time location through the taxi application API. The next step is to trigger and trigger mapping (302) as shown in FIG. 3. Landmark & trigger mapping (302) is a crucial process that involves establishing a framework for determining when and where to display AR ads based on the user's location and proximity to specific landmarks. Landmark database acts as a repository of information about landmarks along designated taxi routes. Landmark database contains precise latitude and longitude data for each landmark, enabling accurate geolocation on maps and triggering, information about businesses or brands associated with each landmark, crucial for targeting relevant ads and pre-designed AR ad experiences tailored to each landmark, ready for display when triggered. Trigger zone calculations establish virtual boundaries around landmarks to activate AR ads when a user enters the designated area. The trigger zone calculations utilize geofencing method that employs virtual fences (geofences) with customizable radii to define trigger zones. The calculation factors are estimated travel time that considers average speed and traffic patterns to estimate when a user is likely to approach a landmark, distance traveled that tracks the user's progress along the route to determine their proximity to landmarks, and landmark visibility that may factor in visual accessibility of landmarks to avoid triggering ads when a landmark isn't clearly visible. The application continuously tracks the user's location through the taxi application API. When the user enters a geofence (landmark area), trigger the ad display.

The predictive ad selection (303) is the next step involved in the method as shown in FIG. 3. Predictive ad selection (303) aims to go beyond just triggering ads based on location by factoring in user context and preferences to deliver hyper-relevant and engaging AR experiences. The contextual analysis involves gathering and analyzing various data points to predict the ad categories most likely to resonate with the user's past booking details, favorite brands, interests gleaned from app usage or user profiles can inform relevant ad categories, travel purpose and time of a day. To ensure a seamless user experience, pre-downloading potential ad content is crucial. Based on the chosen route, the system identifies potential landmarks and predicts the most likely ad categories using contextual analysis. The relevant immersive ad content (3D models, animations, interactive elements) for predicted categories is downloaded in advance to the user's smartphone. In another embodiment, immersive ad delivery (304) brings the carefully selected and pre-downloaded AR ads to life, transforming the taxi ride into an engaging and interactive journey. The taxi application continuously tracks the user's location within trigger zones defined around landmarks. Upon entering a trigger zone, the system automatically activates the corresponding pre-downloaded immersive ad content. A subtle notification or vibration signals the user about the available ad. The notification method and timing should align with user settings and preferences to avoid intrusiveness. The system offers various engaging formats, for example, Augmented Reality (AR) which overlays virtual elements onto the live camera view, blending digital content with the physical environment, AR may also involves landmark information which displays interactive labels, descriptions, or historical facts about the landmark, virtual characters or guides that introduces virtual brand mascots or guides to interact with the user, or product simulations that allows users to visualize products in real-world spaces (e.g., placing furniture in their homes).

Effective user interaction and data collection (305) are crucial for optimizing landmark-triggered AR ads, ensuring a positive user experience and valuable insights for advertisers. The system monitors various user interaction metrics to gauge the effectiveness and popularity of the AR ads such as counting how many users view the triggered ad at all, tracking specific interactions within the ad, like clicking on elements, activating features, or participating in game, and measuring whether the ad prompted the desired action, such as visiting a website, making a purchase, or signing up for a service. The system 300 offers various ways for users to provide feedback on their AR ad experience such as prompting users to rate the ad, suggest improvements, or choose preferred ad types, allowing users to express their opinions and ideas in detail through text or voice messages, and integrating feedback as part of interactive challenges or reward systems can incentivize participation. The journey doesn't end with delivering immersive AR ads. Continuously analyzing user data, refining ad delivery, and managing partnerships are crucial for optimizing performance (306) and ensuring a thriving ecosystem. The system (300) leverages the collected data on user interaction, preferred ad types, and travel patterns to gain valuable insights. The system (300) analyzes which ad categories and formats resonate best with different user segments and contexts and refines the predictive ad selection algorithms to deliver even more relevant and engaging ads based on user data. The system (300) also analyzes user behavior to adjust the size and location of trigger zones for optimal timing and ad presentation. The system (300) continuously updates pre-downloaded ad content based on user feedback and data-driven insights and integrates new AR technologies and features to offer richer and more engaging experiences.

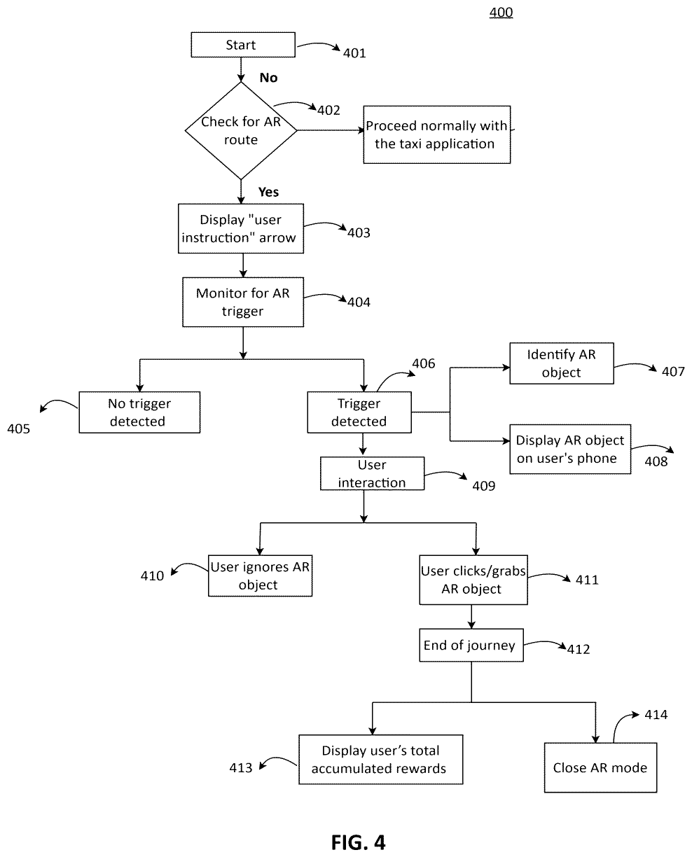

FIG. 4 illustrates a flowchart showing a system of immersive landmark-triggered advertising in taxi rides (400). The system (400) first checks for AR route (402) to ensure the system (400) delivers AR ads only when conditions are suitable, enhancing user experience and avoiding potential disruptions. The system (400) analyzes the user's chosen route in the taxi application (103). The system (400) checks for several factors such as geofence coverage, landmark database. If route is AR-compatible, a visual cue, typically an arrow or similar symbol, appears on the taxi app's interface. This symbol often has a label like “user interaction” or “AR experience” (403) to clarify its purpose. This indication signals to the user that they can anticipate AR experiences during their ride, and it sets expectations, encourages engagement, and minimizes surprise when ads are triggered. If route is not AR-compatible, application functions as usual (415), without any AR-related features or notifications. This ensures a seamless experience for users in areas without AR support or those who prefer a traditional ride experience. The system (400) comprises monitor for AR trigger (404) to determine the precise moments when AR ads should be activated, ensuring timely and relevant delivery within the taxi ride context. The taxi application (103), with user consent, actively tracks the user's location throughout the journey. This typically involves GPS and other sensors to pinpoint their position accurately. The system constantly compares the user's location to the designated AR trigger zones along the route. These trigger zones are usually virtual boundaries (geofences) surrounding specific landmarks or points of interest. If the user is not within a trigger zone (405), the taxi application (103) continues its normal functionality without AR interactions. The system continues to monitor for potential triggers until the user reaches a designated area. When the user enters a trigger zone (406), the system activates the following steps i.e identify AR object (407) and display AR object on user's phone (408). The system (400) pinpoints the specific landmark associated with the trigger by leveraging the triggered geofence and user location data. The landmark database is accessed to retrieve pre-designed AR content (3D models, animations, information) specific to that landmark. Depending on the system's (400) capabilities, contextual factors like user preferences, time of day, and past interactions might further personalize the selected AR object. The chosen AR object is precisely positioned and scaled to seamlessly integrate with the real-world view captured by the user's smartphone camera. The AR object is seamlessly integrated into the user's smartphone (102) screen, overlaying the real-world view with virtual content. Depending on the chosen AR object, interactive elements like buttons, animations, or touch-sensitive areas might activate, allowing users to explore and engage with the content. A subtle on-screen interface might be added to provide additional information, navigation options, or call-to-action buttons for further engagements.

The system (400) employing user interaction (409) to empower users with control over their AR ad experience, enabling them to engage with content on their own terms and fostering active participation. The system (400) seamlessly overlays the AR object onto the user's smartphone screen, creating a blended reality experience. If the user chooses not to engage (410) immediately, then AR object remains visible but doesn't actively demand attention, and respects user preferences and avoids forceful interruptions. When the user interacts with the AR object (411) (typically through tapping, swiping, or dragging), the system (400) accurately registers the user's actions, initiating corresponding responses. Various actions might be triggered, depending on the specific AR object and its design such as displaying more comprehensive information about the landmark, product, or brand, launching interactive games, quizzes, or virtual tours related to the content, unlocking discounts, coupons, or points for user engagement, or directing users to websites, social media pages, or online stores for further exploration. The end of journey (412) stage marks the final chapter in the user's immersive AR ad experience within the taxi ride. It's an opportunity to provide closure, offer feedback, and potentially incentivize further engagement. As the user reaches their destination, the AR mode is gracefully closed (414). This ensures a smooth transition back to the taxi app's standard interface without lingering distractions. Depending on the system design, a subtle farewell message or animation might be used to signal the end of the experience. Reward highlighting (413) stage shines a spotlight on the user's accumulated rewards earned through their AR interactions throughout the journey. The total rewards, be it points, discounts, or special offers, are prominently displayed on the screen. This provides immediate feedback and reinforces the value of actively engaging with the AR content.

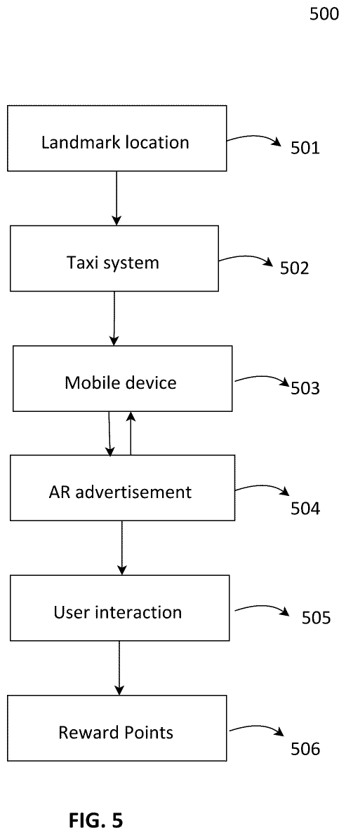

FIG. 5 illustrates a landmark-triggered mobile AR ad system utilizing reward collection at the end of journey. The system (500) starts with the landmark location (501) which are the anchors around which the entire landmark-triggered AR ad experience in taxi rides revolves. Landmarks are carefully chosen for their cultural significance, historical importance, or architectural intrigue. Landmarks are geographically dispersed throughout the city, ensuring passengers encounter unique AR experiences throughout their journeys. Diverse landmark types are chosen-museums, monuments, historical sites, modern structures-catering to different passenger interests and ad campaigns. Each chosen landmark is precisely mapped using GPS coordinates, forming virtual trigger zones surrounding it. Geofence sizes can be adjusted depending on the landmark's scale and complexity of the intended AR experience. Precise mapping ensures the AR content triggers seamlessly as the taxi enters the geofence, avoiding awkward delays or missed opportunities. The taxi system (502) in landmark-triggered AR advertising plays a pivotal role, acting as the central hub orchestrating the entire experience. The taxi system (502) housing with the key components such as AR display, GPS/sensor, and internal network. AR display projects captivating AR visuals within the taxi, typically integrated into headrests, infotainment screens, or even windows. GPS/sensor pinpoints the taxi's location and gathers environmental information. GPS triggers relevant ads as the taxi enters a pre-defined geofence around a landmark, while sensors adjust the AR display for realism. Internet network facilitates seamless communication between the system's components, ensuring smooth display and interaction with the AR content. As the taxi approaches a landmark, the GPS triggers the system based on the pre-defined geofence. The system fetches the most relevant AR ad content for the specific landmark from the ad server. The internal network transmits the ad content to the AR display. The AR display projects the content onto the headrests, infotainment screen, or windows, depending on the configuration. Sensors like the accelerometer might adjust the

AR content based on the taxi's movement and orientation, enhancing realism. Passenger interaction with the AR content (clicks, swipes) is captured and transmitted through the internal network, potentially influencing future ad choices. The passenger mobile device (503) or phone or tablet plays a crucial role in the mesmerizing world of landmark-triggered AR taxi ads. The AR application downloaded and installed on passenger's device (503), this application acts as the bridge between you and the taxi's system (502). AR application receives AR content from the taxi via Wi-Fi or cellular data, typically provided by the taxi service. The AR application overlays this content onto the live camera feed captured by your device, seamlessly blending the augmented visuals with the real world. The passenger can interact with the AR elements through taps, swipes, or other gestures supported by the application, enriching the advertising experience. The camera on passenger's device acts as the canvas for the AR magic. It captures the real-world scenery in real-time, providing the foundation onto which the augmented elements are layered. A stable Wi-Fi or cellular data connection is vital for passenger devices to communicate with the taxi's system. AR advertisement (504) acts as the heart of the landmark-triggered AR experience. This is where creativity meets technology, transforming ordinary taxi rides into captivating journeys. The Ad content provides creative visuals, animations, interactive elements, or informative overlays related to the specific landmark that can be displayed. Content is tailored to the landmark, enhancing its significance, and engaging the user. Ads might encourage clicks, website visits, or product purchases, creating a bridge between the virtual and real worlds.

User interaction (505) is where the experience comes alive. Passengers can tap, swipe, or interact with the AR content, triggering additional information, animations, or rewards. Passengers choose whether to engage with the ad, ensuring a non-intrusive experience. Reward points (506) add a layer of incentive and gamification in the system (500). Points are awarded for actively engaging with the AR content. This could include tapping on specific elements, completing quizzes, participating in AR games, or even sharing their experience on social media. The complexity and effort involved in the interaction can determine the number of points earned. Simple taps might offer quick rewards, while deeper exploration or completing challenges could yield bigger point boosts. Accumulated points can be redeemed for immediate gratification, offering discounts on taxi fares, nearby restaurants, or local attractions. Redeemable points create a sense of value and reward passenger engagement, fostering brand loyalty and encouraging them to choose taxis with AR experiences in the future.

As a passenger near a landmark, the taxi's GPS triggers the system. The system transmits your location and device information to the ad server. The ad server selects the most relevant AR ad based on the landmark, your data, and current campaign settings. The ad content is sent to the taxi's system and transmitted to your device via Wi-Fi. The AR app on your device overlays the ad content onto the live camera feed, presenting it seamlessly within the taxi. The passenger can choose to interact with the AR content, triggering further animations, information, or earning reward points. Upon completion of the journey, accumulated points might be redeemable for various benefits, further incentivizing future engagement.

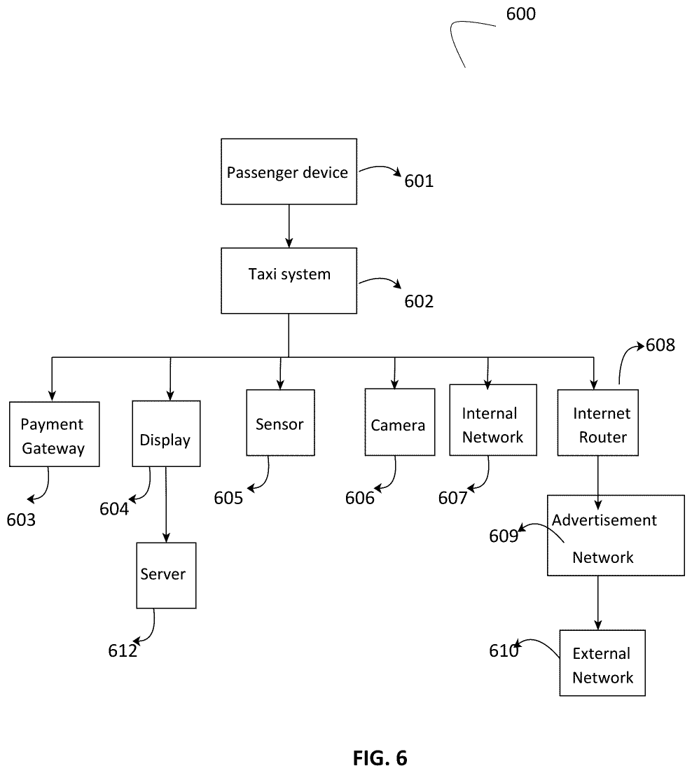

FIG. 6 illustrates the complex network of interactions and components involved in delivering augmented reality advertisements within a taxi environment. The network (600) comprises a passenger device (610) typically refers to the passenger's smartphone or tablet and serves as the primary interface for interacting with the taxi's AR ad system. An application installed on the device (610) that displays AR content overlaid on the live camera feed. A camera is also integrated inside the device (601) that captures the real-world view used for AR overlay and having Wi-Fi or cellular data connection to receive ad content and communicate with the taxi's system. Further, the network (600) involves taxi system (602) handles the core functionality of the taxi ride, including booking, navigation, and payment processing. The taxi system (602) comprises the following key components payment gateway (603), Ad display (604), GPS/sensor (605), camera (606), internal network (607), internet router (608), ad server (612), ad network (609), external network (610). AR display (604) is used to project AR content directly onto the back of the headrest for individual passenger viewing and superimposing AR elements onto the existing screen, visible to all passengers. Ad display (604) sometimes utilizes transparent displays or holographic projectors to blend AR content with the real-world scenery outside the window or can be integrated to the passenger's device (601) too. AR display (604) renders augmented reality advertisements within the taxi's interior for passenger viewing. GPS/sensor (605) acts as the eyes and ears of the system, providing crucial information for contextual ad delivery and accurate AR placement. GPS pinpoints the taxi's location in real-time, triggering relevant AR experiences as it enters pre-defined geofences (areas around landmarks). Sensors such as accelerometer, gyroscope, and other sensors can adjust the AR content depending on the taxi's movement and orientation, ensuring realistic representation. The system (600) utilizes camera (606) is integrated into the taxi for additional data collection, security monitoring, and recording purposes. The camera (606) identifies passenger interactions with AR objects for personalized ad experiences and provides additional depth information for more sophisticated and interactive AR content.

Further, the system (600) has an ad server (612) which acts as the central repository and delivery hub for AR ad content. The ad server (612) houses various types of AR ad formats (3D models, animations, interactive elements) for different brands and campaigns. Ad server (612) leverages passenger and location data to deliver relevant and impactful ads based on landmarks, time of day, or passenger demographics and tracks campaign performance, manages advertiser budgets, and optimizes ad delivery based on real-time data. Internal network (607) ensures smooth communication within the taxi system itself. Internal network (607) facilitates data exchange between various components like GPS, sensors, AR display, and internal processing units and synchronize different functions to ensure seamless delivery of the AR ad experience at the right time and place. The payment gateway (603) acts as the central hub for managing financial transactions between passengers and the taxi service, which facilitates various payment methods like credit cards, mobile wallets, and local payment systems. The payment gateway (603) automatically calculates fare based on distance, time, and any applicable fees, issuing digital or printed receipts for passenger records, and ensures secure transaction processing with data encryption and fraud prevention measures.

Internet router (608) serves as the gateway between the taxi's system and external networks like the internet in FIG. 6. Internet router (608) enables the taxi's system to send and receive data to/from ad servers, payment gateways, and other online resources. Internet router (608) implements firewalls and security protocols to protect the taxi's system from cyberattacks and unauthorized access and provides backup connections or network switching mechanisms to ensure minimal disruption in case of internet outages. Ad network (609) acts as central repository for storing and managing advertisement content for the AR ad platform. Ad network (609) hosts various types of AR ad content (3D models, animations, videos) for different brands and campaigns and utilizes passenger and location data to deliver relevant and contextual ads to specific taxi routes and users. Ad network (609) track campaign performance, manages advertiser budgets, optimizes ad delivery based on real-time data and handles billing and invoicing of taxi services for displaying advertisements. External networks (610) provide vital connections to the outside world and enable data exchange with the ad server, cloud-based services, and other online resources. For real-time updates, navigation data, and potential passenger communication (if allowed). As a passenger passes a landmark, the passenger's device (601) GPS triggers the taxi's system (602). The system sends the passenger's location and passenger data (anonymously, of course) to the ad server (611) and ad network (609). The ad server (611) and ad network (609), based on the passenger's data and the landmark, select the most relevant AR ad content. The content is sent to the taxi's system (602) via the internet router (608). The passenger device (601), connected to the taxi's Wi-Fi, receives the content, and displays it on user's screen through the AR application, blending it seamlessly with the real world captured by passenger device's camera. As the passenger interacts with the AR content, the passenger's device might send information back to the system, potentially influencing future ad choices. Finally, at the journey's end, the payment gateway (630) securely processes passenger payment for the ride.

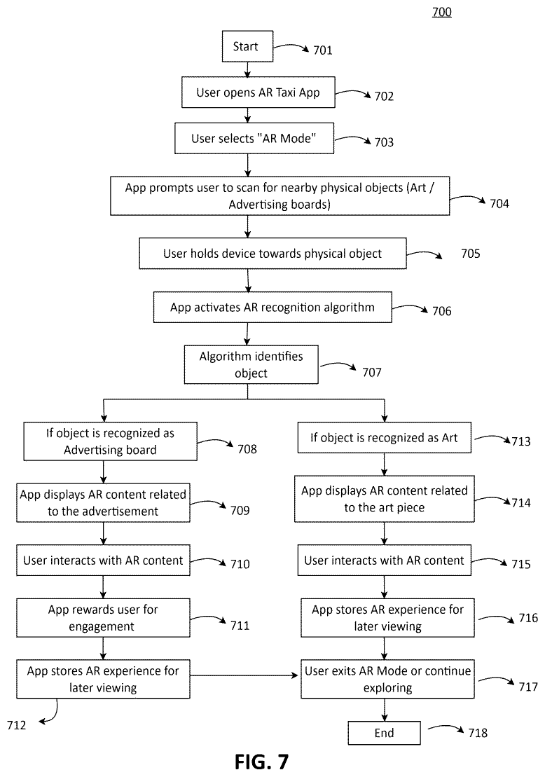

FIG. 7 represents flowchart for the invention involves visualizing the sequence of steps involved in using the AR taxi app for interacting with advertising boards and art. Here's a simplified flowchart. The flowchart (700) starts with the user opening the AR Taxi app (702) and selecting the “AR Mode” option (703). The user launches the AR Taxi app on their device, such as a smartphone or tablet. Within the app, they navigate to the options or settings menu and select the “AR Mode” (703) option to activate augmented reality features. Once in AR Mode, the app prompts the user with instructions or a message to scan for nearby physical objects (704). This instruction may be presented through text prompts, icons, or visual cues within the app's interface. Following the app's prompt, the user holds their device, with the AR Taxi app open, towards a physical object of interest (705). This object could be an art piece, an advertising board, or any other recognizable physical item. Upon detecting that the device is pointed towards a physical object, the AR Taxi app activates its image recognition algorithm (706). This algorithm analyzes the visual input from the device's camera to identify patterns and features that match pre-defined images in the app's database.

If the image recognition algorithm successfully identifies the object (707), the app determines whether it corresponds to an art piece or an advertising board. If the object is recognized as art (713), the app displays augmented reality content related to the art piece (714). This could include information about the artist, historical context, or interactive elements allowing the user to explore the artwork in more detail. If the object is recognized as an advertising board (708), the app displays AR content related to the advertisement (709). This could include interactive elements such as videos, games, or links to promotional offers. The user interacts with the displayed AR content (710, 715), engaging with the app's features related to the identified object. For art pieces, this interaction might involve exploring additional information, zooming in on details, or sharing the artwork with others. For advertising boards, interaction might include watching videos, playing games, or clicking on links for more information. As the user engages with the AR content, the app may reward them (711) with points, vouchers, or other incentives.

These rewards serve to encourage continued engagement with the app and its augmented reality features. Additionally, the app stores the AR experience (712, 716), including any interactions or engagement metrics, for later viewing or analysis. Once the user has finished interacting with the AR content, they have the option to exit AR mode and return to the app's main interface. Alternatively, they may choose to continue exploring their surroundings and scanning for more physical objects to interact with using the AR features of the app.

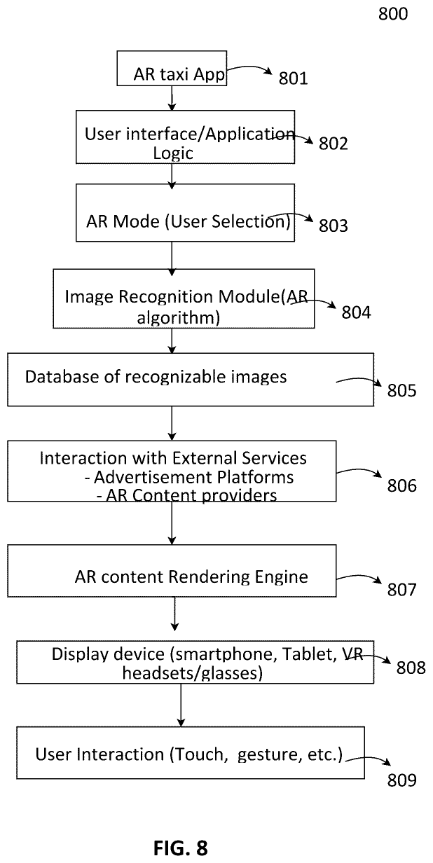

FIG. 8 represents block diagram (800) illustrating the components and flow of the AR Taxi app for interacting with advertising boards and art. FIG. 8 comprises first component AR Taxi App (801) which is the primary application responsible for orchestrating the entire augmented reality (AR) experience. AR taxi App (801) acts as a platform for users to engage with AR content, including art pieces and advertising boards, through their mobile devices. The system involves second component User interface/Application logic (802). The user interface (UI) of the AR Taxi app is responsible for presenting information and interactive elements to the user. It handles user interactions such as mode selection, navigation through the app's features, and overall user experience design. The application logic governs the behavior of the app, including processing user inputs, managing data flow, and coordinating various functionalities. AR Mode (802) is a feature within the AR Taxi app that users can activate to enter augmented reality mode. By selecting this option, users signal their intent to engage with AR content, triggering the activation of AR functionalities within the app. The image recognition module (803), also known as the AR algorithm, employs image recognition technology to identify physical objects captured by the device's camera. This module analyzes visual data to match captured images with pre-defined patterns stored in its database, enabling the recognition of objects such as art pieces or advertising boards.

Database of Recognizable Images (805) is a database that serves as a repository of images that the AR algorithm can recognize during the object identification process. It contains a curated collection of images representing various art pieces, advertisements, and other content that users may encounter while using the AR Taxi app. In system, further involves Interaction with External Services (APIs) (806) in which the AR Taxi app interacts with external services, such as advertisement platforms and AR content providers, through application programming interfaces (APIs). These interactions facilitate the retrieval of relevant data, such as updated advertising content or additional AR experiences, to enrich the user's AR experience. AR content rendering engine (807) is responsible for rendering augmented reality content based on the recognition results obtained from the AR algorithm and user interactions. It translates recognized objects into immersive AR experiences, overlaying digital content onto the physical world captured by the device's camera. The display device (808) refers to the device used by the user to view the AR content generated by the AR Taxi app. This device could be a smartphone, tablet, or VR headset equipped with a screen capable of rendering AR visuals. The final component involves user interaction (809) that encompasses the various ways in which users engage with AR content displayed by the AR Taxi app. This includes interacting with AR elements using touch, gestures, or other input methods supported by the user's device, such as tapping on virtual buttons, swiping to navigate, or performing gestures to manipulate AR objects.

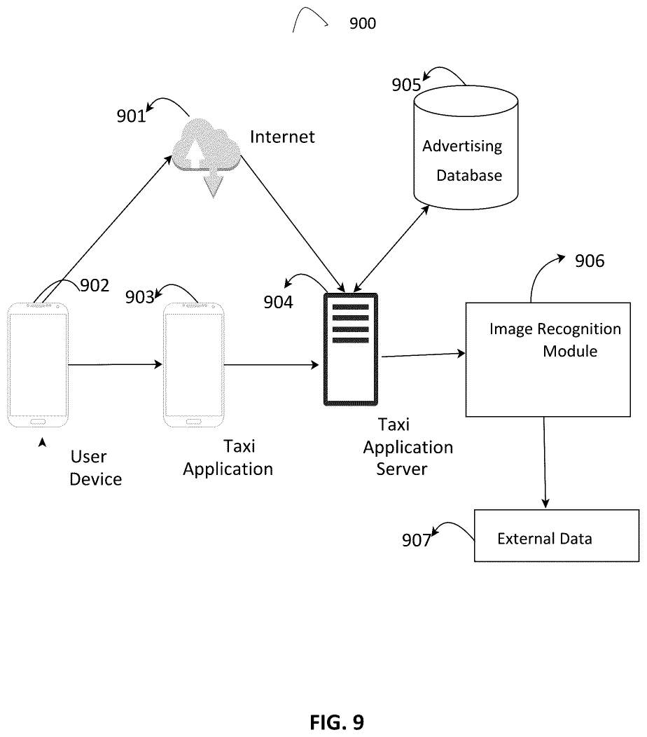

FIG. 9 represents a network architecture of the AR Taxi app for interacting with advertising boards and art. The network architecture (900) comprises internet (901) which serves as the global network infrastructure that connects all the components of the AR Taxi app to the worldwide web. Internet (901) enables communication between various components of the app and allows them to exchange data and information seamlessly. The internet (901) provides the foundation for the app's functionality by facilitating connectivity and access to external resources and services. The AR Taxi App Server (904) acts as a central server responsible for managing communication between the user's device and other services. AR taxi application server (904) hosts backend services required for the functioning of the app, such as data processing, storage, and retrieval. The server (904) facilitates interaction between the user's device and external data sources, APIs, and other backend systems. The AR app server (904) plays a crucial role in ensuring the smooth operation of the AR Taxi app (903) by handling various tasks and processes behind the scenes. The user's device (902), such as a smartphone or tablet, serves as the platform for accessing the AR Taxi app (903) and interacting with its features. User's device (902) provides the interface through which users can engage with AR content, navigate the app, and perform actions. The device's (902) hardware capabilities, including its camera, display, and processing power, contribute to the overall AR experience. Users rely on their devices to run the AR Taxi app (903) and immerse themselves in augmented reality environments.

The AR Taxi App (903) is the software application that hosts the logic and features required for displaying augmented reality content and facilitating user interactions. The AR taxi app (903) serves as the user interface, providing a platform for users to access AR content, navigate the app's features, and engage with advertisements and art pieces. The app (903) manages the overall flow of the AR experience, orchestrating interactions between the user, the device, and external data sources. The AR taxi app (903) incorporates AR features, including image recognition, rendering, and interaction, to create immersive experiences for users. The Image Recognition Module (906) is a component of the AR Taxi app (903) responsible for identifying advertising boards and art pieces through image recognition technology. Image recognition module (906) analyzes visual data captured by the device's camera to recognize objects in the user's surroundings. The module (906) employs advanced algorithms to process images and match them against a database of recognizable images, enabling the app to identify and interact with specific objects. The Database of Recognizable Images (905) stores images used for AR recognition and interaction within the AR Taxi app (903). Database (905) contains a collection of images representing advertising boards, art pieces, and other objects that users may encounter. The database (905) serves as a reference for the Image Recognition Module, allowing the app to identify and interact with recognized objects accurately. External Data APIs (907) provide real-time data from advertisement platforms, art databases, and other sources for AR content and advertising. These APIs enable the AR Taxi app (903) to access and retrieve information such as updated advertising content, art descriptions, and user preferences. By interfacing with external APIs (907), the app (903) can dynamically update its content and provide personalized experiences for users. The Display Device, typically the screen of the user's smartphone or tablet, is responsible for displaying AR content to the user. It presents visual information, including augmented reality overlays, advertisements, and art pieces, in a format that is easily viewable and interactable. The display device plays a critical role in delivering immersive AR experiences to users, enhancing their engagement and interaction with the app. User Interaction encompasses the various ways in which users engage with AR content and advertisements through the AR Taxi app. It facilitates user engagement through touch, gestures, voice commands, and other input methods supported by the device. User Interaction enables users to interact with displayed AR content, explore art pieces, view advertisements, and perform actions such as tapping, swiping, and selecting options within the app.

While a number of preferred embodiments have been described, it will be appreciated by a person skilled in the art that numerous variations and/or modifications may be made in the invention without departing from the spirit or scope of the invention as broadly described. The present embodiments are, therefore, to be considered in all respects as illustrative and not restrictive.

1. A method for displaying Augmented Reality comprising the steps of:
a. identifying physical objects, including a plurality of advertising boards and art pieces, through image recognition technology;
b. rendering Augmented Reality content related to the identified objects on the user's device;
c. facilitating user interaction with the Augmented Reality content through touch, gestures, and other input methods.

2. The method of claim 1, wherein the Augmented Reality content includes but not limited to digital overlays, animations, videos, and interactive elements associated with the identified objects.

3. The method of claim 1, wherein capturing Augmented Reality experiences and user interactions comprises dynamically sourcing real time data from surroundings encountered during the taxi ride, processing said data to generate interactive augmented reality content and presenting said content on a user's mobile device in real time, including but not limited to advertisements, informational overlays and contextual prompts.

4. The method of claim 3, wherein the system tailors Augmented Reality experiences based on user preferences, geographic location, and interaction history during the taxi ride.

5. The method of claim 1, wherein the system incentivizes user engagement with augmented reality content by rewarding users with points, vouchers, or redeemable rewards based on the interaction with the said content, including but not limited to completing tasks, viewing advertisements, interacting with the virtual or augmented reality objects during the taxi ride.

6. The method of claim 5, wherein the system interfaces with external data sources, such as advertisements platforms and art databases, to procure real time data for generating augmented reality content and advertisements.

7. The method of claim 6, wherein the system integrates with external APIs and services to dynamically fetch additional augmented reality content and resources.

8. The method of claim 7, wherein the image recognition module utilizes machine learning algorithms to improve object recognition accuracy over time.

9. The method of claim 7, wherein the system displays AR content in various formats, including 2D overlays, 3D models, and spatial audio.

10. The method of claim 7, further comprising analyzing user engagement metrics to optimize AR content delivery and user experience.

11. A system for displaying Augmented Reality (AR) content, comprising:
a. an image recognition module for identifying physical objects including advertising boards and art pieces;
b. a rendering mechanism to display AR content related to the recognized objects on the user's device;
c. interactive interface components for enabling user engagement with the AR content originally displayed on the identified physical objects including advertising boards, facilitated through touch gestures and other input methods.

12. A system according to claim 11, wherein the rendering engine supports real-time rendering of AR content based on user location and orientation.

13. A system according to claim 11, further comprising a database of a plurality of recognizable images for AR object recognition and interaction.

14. A system according to claim 11, wherein the user interface includes intuitive controls and navigation options for seamless AR content exploration.

15. A system according to claim 14, wherein the system communicates with external services and APIs to retrieve updated AR content and data.

16. A system according to claim 14, wherein the system offers gamified experiences, challenges, and rewards to encourage user engagement with AR content.

17. A system according to claim 16, wherein the system integrates with social media platforms for sharing AR experiences and content with other users.

18. A system according to claim 16, wherein the system utilizes augmented reality markers, QR codes, or geolocation data for enhanced object recognition.

19. A system according to claim 18, further incorporating analytics and reporting functionalities to monitor user engagement and performance metrics.

20. A system according to claim 19, wherein the system supports offline AR experiences, caching content for uninterrupted usage in areas with limited internet connectivity.
